(19) United States
(12) Patent Application Publication
(10) Pub. No.: US 2010/0264639 A1
(43) Pub. Date: Oct. 21, 2010

(54) Album Covering

(76) Inventors: Heather Lovern, Lilburn, GA (US); Charles Lovern, Lilburn, GA (US)

Correspondence Address: LEWINSKI LAW GROUP LLC, 4508 EXMOOR DR., MARIETTA, GA, 30067, US

(21) Appl. No.: 12/762,353

(22) Filed: Apr. 18, 2010

Related U.S. Application Data
(60) Provisional application No. 61/170,638, filed on Apr. 19, 2009.

(51) Int. Cl. B42D 3/04; B42D 3/08

(52) U.S. Cl. 281/34; 281/35

(57) ABSTRACT

An embellished album covering is configured to appear as an article of clothing. An album covering can enhance the appearance of a photo album, scrapbook, memory book, and the like, be customizable, and can commemorate an event or time period. An album covering can be configured to have the appearance of a military uniform, comprising authentic military service fabric, and having embellishment consistent with an authentic military uniform, such as a collar and front pockets. A military service album covering can be personalized with proper placement of name tape, rank insignias and various military uniform adornments. An album covering can be configured to slidingly receive an album, and be removable from the album. A kit can include an album, an album covering configured to cover the album, and various adornments for personalization of the album covering.

### CROSS-REFERENCE TO RELATED APPLICATION

This application claims priority from U.S. Provisional Application No. 61/170,638 entitled “Military Uniform Scrapbook Cover Kit” filed on Apr. 19, 2009 for co-inventors Heather Tracey Lovern and Charles B. Lovern, the content of which is incorporated in its entirety herein by reference.

### FIELD OF INVENTION

This invention relates generally to albums and more particularly to enhanced album covers having the appearance of an article of clothing.

### BACKGROUND OF INVENTION

Albums, such as photo albums, scrapbooks, memory books, and the like, provide a means of preserving photographs, printed articles, cards, invitations, keepsakes, and other memorabilia. A typical album comprises a front and rear cover composed of a sturdy inflexible material that provides structure to the album as well as protection to its contents. A spine between the front and rear covers typically includes an attachment means for attaching multiple pages or sheets on which the photographs or keepsakes can be positioned and secured. Mass production of albums often results in the manufacture of albums that, while fully functional, are rather commonplace, or unremarkable in appearance. However, many consumers desire an album with an attractive, interesting, or personalized outward appearance. Furthermore, as the purpose of an album is to both preserve and display keepsakes for the enjoyment and edification of the owner as well as other interested parties, it is often desired that a decorative or personalized cover be sufficiently durable to withstand repeated handling. Since an album may be soiled and smudged by those holding and perusing it, it is often desirable that an album cover be cleanable, preferably washable.

To satisfy the aesthetic interests of consumers, albums can be manufactured with ornately printed covers that provide an attractive album facade. Alternatively, as disclosed by U.S. Patent Application No. 20060237961, filed by Partain and entitled “Scrapbook and Photo Album Covers”, a pair of album cover panels can be purchased separately, attached to the front and rear covers of a scrapbook or photo album, and bound together by ribbons to enhance an album's appearance. While these improvements may improve a scrapbook's outward appearance, they may still fail to provide the degree of personalization sought by some consumers. In particular, they may not satisfy those persons seeking an album cover that can convey or commemorate a particular event, occasion, or time period of a individual's life. In addition, the durability and degree to which such covers can be cleaned is often in question.

U.S. Patent Application 20070106690, entitled “Personalized Memory Album” filed by Denniston et al., discloses creating a personalized memory album including selecting image elements, uniting the selected elements in a collected image file, printing the collected image file onto fabric media sheets and assembling the sheets into a personalized memory album. Denniston et al. discloses customizing an album by selecting images from a set of predetermined set of images contained in a software package. Thus, the types of images and personalizations that can be used are limited to the finite set provided on an enclosed software CD. Furthermore, the Denniston et al method and system require a user to have access to a computer compatible with the software, and a printer compatible with the fabric media sheets. The final appearance of the album is thus dependent on printer output quality. In addition, although personalized to the extent that a user can select the images used on the cover, the Denniston album cover is not configured to receive user-selected decorations other than printed images. There remains a need for a personalized album cover that does not require a user to have access to a computer and peripheral equipment that satisfy predetermined specifications.

U.S. Pat. No. 5,676,482 to Hawkins discloses a machine-washable album with removably affixing means. The album is for displaying photographs, drawings objects and the like and includes a front cover, a back cover and a plurality of pages disposed therebetweeen. Each of the pages includes an attachment means whereby a photograph, drawing or object may be removably attached or affixed to the page. The album substantially comprises machine-washable material with the front and back covers and interior pages sewn together to provide a washable album. In contrast to the album cover of Denniston that comprises a fabric media sheet that can be attached to a separate pre-existing traditional album, the Hawkins album comprises a single body composed entirely of machine-washable fabric. However, to machine wash the cover of the album, the part most likely to be soiled, the entire album must be machine-washed, necessitating the removal and subsequent replacement of all the photos, cards, clippings and other momentos contained in the album. The removal and replacement process can be a time-consuming task that puts the contents of the album at risk for loss or damage while separated from the album. Furthermore, Hawkins discloses an album bound with soft, flexible materials that can be easily manipulated by a child or any other individual with limited small motor coordination. While adequate for its intended purposes, it may not provide the structural rigidity and protection desired by some consumers for their keepsakes, particularly those keepsakes of high sentimental value.

There remains a need for an album covering that can enhance the appearance of a standard album. There is a need for an album covering that is configured for adornment by a user. There is a further need for an album covering that is configured for personalization without requiring the user to have access to a computer and associated peripheral equipment. There is a need for an album covering that can be washed without requiring a user to remove all album content prior to the washing. There is a need for an album covering that can convey or commemorate a special occasion or a particular time period or activity in an individual's life.

### SUMMARY OF THE INVENTION

In an exemplary embodiment, the invention provides an album covering comprising a front section configured to cover a front cover of an album, a spine section configured to cover a spine of the album, and a rear section configured to cover a rear cover of the album. The front, spine and rear sections are made of fabric. The covering is configured to appear as a garment made from the fabric so that an album can appear to be wearing the garment. In an exemplary embodiment a single layer of fabric seamlessly extends through the front, spine and rear sections to provide a smooth, continuous look that reinforces the impression that the album is wearing the garment. The front section can include a neckline portion, and can be configured to include an underlayer so that a layered look can be achieved. For example, an album covering can look like a shirt over an undershirt. To commemorate an event or activity, an album covering can resemble various articles of clothing, by way of example, but not limitation, infant or child wear, formal attire, a school uniform, a military uniform, occupation uniform, or an organization uniform such as a scouting uniform or a sports team uniform. In an example embodiment, an album covering is configured to slide onto an album and be removable. In an example embodiment, an album cover is configured to receive adornments, for example, but not limited to, jewelry for a formal attire covering, a baby accessory for an infant wear covering, badges for a scouting uniform, school insignia for a school uniform, and the like.

An embodiment of the invention can comprise a kit that includes an album and an album covering configured to cover the album. An album of the kit can include a front cover, a rear cover and a spine. An album covering of the kit can include a front section to cover the front cover, a rear section to cover the rear cover, and a spine section to cover the album spine portion, and the covering is configured to appear as a garment made from said fabric. In an exemplary embodiment the front section is embellished with a neckline portion that has the appearance of a neckline for a garment. An exemplary kit can include one or more adornments or accessories for the album covering. For example, a sports team kit can include an adornment such as a patch or decal that can be embroidered with a team name and attached to an album covering.

In an example embodiment, the invention provides a military service album covering configured to appear as a military service uniform. A military service covering can be embellished with a neckline portion configured to appear similar to that of an authentic military uniform. A military service album covering can be embellished with a loose, liftable collar that facilitates attachment of rank insignia. An example military service album covering can include a military service tape attached to a front section of the military service album covering that identifies a particular military service such as the U.S. Army, U.S. Air Force, U.S. Navy, U.S. Marines, or U.S. Coast Guard. As part of its appearance as an authentic military uniform, a military service album covering can include at least one functional front pocket on a front section of the military service album covering. In an example embodiment, a front pocket can conform to precise military size and shape specifications for a front pocket on a military service uniform. A military uniform album covering can be configured to receive a military service name tape. In an exemplary embodiment, a military uniform covering is configured for proper pin placement in accordance with military specifications.

### BRIEF DESCRIPTION OF THE SEVERAL DRAWINGS

FIG. 1 shows an album covered with an example album covering.

FIG. 2A shows an example album apart from an album covering.

FIG. 2B shows an example album covering separated from an album.

FIG. 3A shows the inner portions of an example album covering.

FIG. 3B shows the inner portions of an example album covering, pulled away from the outer portion.

FIG. 3C shows an example album covering turned inside out.

FIG. 4A shows an example covered album with an album covering having pull through buttons as coupling means.

FIG. 4B shows an example covered album with an album covering having pull-through buttons as coupling means.

FIG. 5A shows an example covered album with an album covering having snap buttons as coupling means.

FIG. 5B shows an example covered album with an album covering having snap buttons as coupling means.

FIG. 6 shows an example covered album with an album covering having hook and loop tape as coupling means.

FIG. 7A shows an example covered album with an album covering having a zipper as a coupling means.

FIG. 7B shows an example covered album with an album covering having a zipper as a coupling means.

FIG. 8 shows an example covered album with an album covering adhered to the album.

FIG. 9A shows an example covered album having a military uniform covering.

FIG. 9B shows an example covered album opened up.

FIG. 9C shows the rear of an example covered album in a closed position.

FIG. 9D shows a example album opened up.

FIG. 9E shows an example military uniform covering.

FIG. 9F shows an example military uniform covering.

FIG. 9G shows an example military uniform covering with collar lifted and adornments.

FIG. 10 shows an example military uniform covering.

### DETAILED DESCRIPTION OF EXEMPLARY EMBODIMENTS

As required, exemplary embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which exemplary embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. Front and rear are used herein to refer to sections of an album covering or covers of an album. As understood herein, a front cover is the cover at the beginning of an album, and a rear cover is the cover at the end of an album. An album covering can be made of fabric. When discussing aspects of an album covering's construction, the terms “right side” and “wrong side” of a fabric are used herein. Often fabric has a “front” or “right” side having a desired pattern or color, and a “reverse” or “wrong” side that does not have the desired pattern or color of the right side. In some cases the front and reverse sides of a fabric are indistinguishable by color or appearance. In general the right side is the exposed side of the fabric that gives a garment its outward appearance, and the wrong side of a fabric is the side that is generally concealed. Typically pieces of fabric are seamed together by stitching on the wrong side of the fabric pieces.

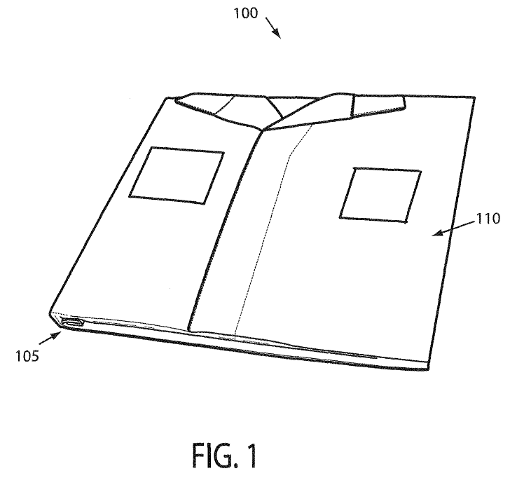

Turning to the figures wherein like numbers represent like elements throughout the several views, FIG. 1 shows an example embodiment 100 of an album 105 covered by an album covering 110. The album covering 110, made from fabric, is embellished to make it look like an article of clothing. When covered with the album covering 110, the album 105 has the appearance of wearing a shirt. The album covering 110 covers the album 105, protecting it and giving it a novel, eye-catching appearance.

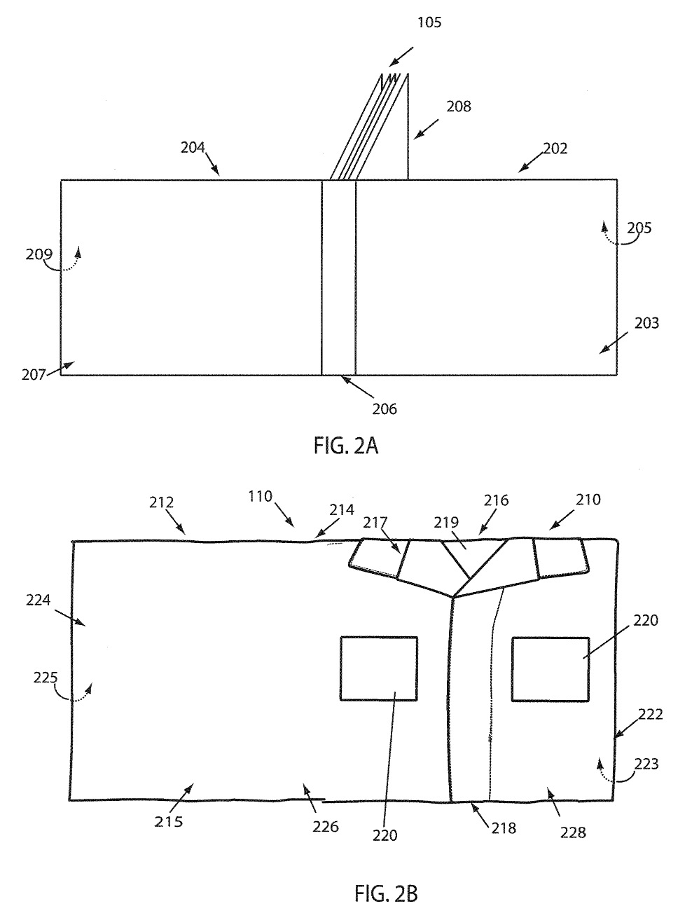

FIG. 2A shows the example album 105 without the album covering 110. The album has a front cover 202, a rear cover 204, and a spine 206. The album 105 can be manufactured from any substance or material. The album 105 includes a plurality of pages 208 bound at the spine 206. The pages 208 can be made from paper, cardstock, plastic, acid-free paper stock, or any suitable material. The pages 208 can be configured to receive photographs, for example the pages 208 can comprise pockets for photographs. The pages 208 can be embodied as plain paper sheets on which clipped articles, cards, photographs, or other keepsakes can be mounted. The album 105 can have any size or dimension; in a preferred embodiment, the album covers 202 and 204 are 13¾ inches in width and 12¾ inches in height.

The front cover 202 includes an outside surface 203 and an inside surface 205. Similarly, the rear cover 204 has an outside surface 207 and an inside surface 209. In an exemplary embodiment, the front and rear covers 202 an 204 have outside surfaces, 203 and 207 respectively, that comprise plain, darkly colored canvas, giving the album 105 a rather commonplace, unremarkable appearance that fails to convey any theme, or convey any clue as to the album contents. In addition, the canvas material, while perhaps durable, may prove difficult to clean. Should the front cover 202 or rear cover 204 be soiled or damaged, the album 105 may be ruined, forcing a user to remove all the contents and transfer them to a different album. Depending on the bindings of the original and replacement album, the types of pages, and whether the pages of one are compatible with the other, the transfer can be a time-consuming process that places the album contents at risk.

FIG. 2B shows the example covering 110 separate from the album 105; the album covering 110 is opened up and spread out. The covering 110 has a front section 210 configured to cover the album front cover 203, a rear section 212 configured to cover the album rear cover 204, and a spine section 214 configured to cover the album spine 206. The front, rear, and spine sections, 210, 212, and 214 respectively, comprise fabric, for example fabric suitable for making a garment. In the exemplary embodiment 110, a first base layer of a first fabric 215 can extend seamlessly through sections 212, 214 and 210 and provide a smooth, continuous look. The first fabric can be any type of garment fabric, but is preferably a washable fabric. The front section 210 can be embellished to have the appearance of a front of a garment, in this case the front of a shirt, made from the fabric 215. Accordingly, the fabric 215 can comprise a fabric that provides a desired garment appearance. For example, denim can be used to give a denim shirt appearance, flannel can be used to give a flannel shirt appearance, and so forth. A variety of garment looks can be achieved through choice of fabric and embellishments. For example, embellishments such as a neckline, collar and two front pockets can give the appearance of a man's shirt. When a particular fabric is employed, for example fabric used for a military uniform, and particular embellishments included, such as functional pockets, a loose, liftable collar, and a service tape, the covering can have the appearance of a military uniform. When solid or striped broadcloth is used, the covering can have the appearance of a man's dress shirt, and can be adorned with a necktie. Thus, an album covering can have the appearance of any of a variety of men's, women's or children's apparel. In an exemplary embodiment, the fabric can be machine washable.

The front section 210 includes a neckline portion 216 that has an appearance as a neckline of a shirt, and includes a collar 217. The neckline portion 216 and collar 217 lead to a center front portion 218 having stitching that resembles that commonly used in the center of a shirt, for example where two shirt panels overlap. In an example embodiment, the center front portion can be configured with functional coupling means that allow it to be opened up, giving the appearance of an opened shirt. For example, buttons can be disposed at the center front portion that can be used to open it up to give the appearance of an opened shirt over an underlying undershirt represented by a separate layer of fabric. The front section 210 further includes a pocket 220, configured to appear as a front pocket of a shirt. In an exemplary embodiment, the pocket 220 is fully functional, configured to receive and hold one or more items, just as a typical front shirt pocket on a shirt. The rear section 212 has no pocket, simulating the back of a person's shirt. The rear section 212 of example embodiment 110 has no neckline; however it is contemplated that a rear section of an album covering can have a neckline or other embellishment that can simulate the back of a shirt. The neckline portion 216 can further include an underlayer 219 that can give the appearance of a shirt or top worn under a collared shirt; for example an undershirt or camisole worn under a separate garment. The underlayer 219 can extend under an opening defined by the neckline portion 216. As discussed above, in an example embodiment, the underlayer 219 can extend beyond the neckline portion to underneath the center front portion 218, and the center front portion 218 can be configured to open up to expose the underlayer 219 and allow attachment of adornments to the underlayer 219. It is further contemplated that the underlayer 219 can be configured to appear as a person's chest rather than a garment layer. Alternatively, an album covering may include an opening at the neckline portion 216 that allows exposure of the encased album.

The front section 210 has an outer portion 222 for covering the outside surface 203 of the album front cover 202, and an inner portion 223 for covering the inside surface 205 of the album front cover 202. The rear section 212 includes an outer portion 224 for covering the outside surface 207 of the album rear cover 204, and an inner portion 225 for covering the inside surface 209 of the album rear cover 204. The example album covering 110 completely covers the outside surface 210 of the front cover 202, and the outside surface 212 of the album rear cover 204. In an example embodiment, a first base layer 226 of first fabric 215 extends seamlessly from outer rear portion 224, through the spine section 214, into the outer front portion 222. The inner portion 223 and inner portion 225 substantially cover the inside surface of the album front cover 202 and the inside surface of the album rear cover 204, extending generally up to the spine section 214. Substantially covering the inside surfaces 202, 204 further protects the album front and rear covers, provides a complete and finished look for the album interior, and reinforces the appearance of an album wearing a garment. In an exemplary embodiment, a second base layer 228 can extend through the outer front portion 222 and inner front portion 223. In an example embodiment, an album covering can be sized to snugly fit a standard-sized album.

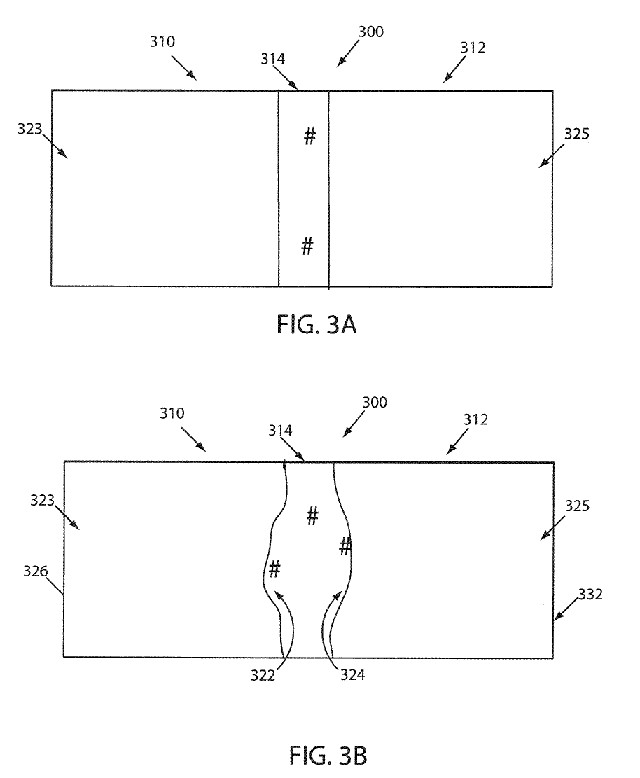

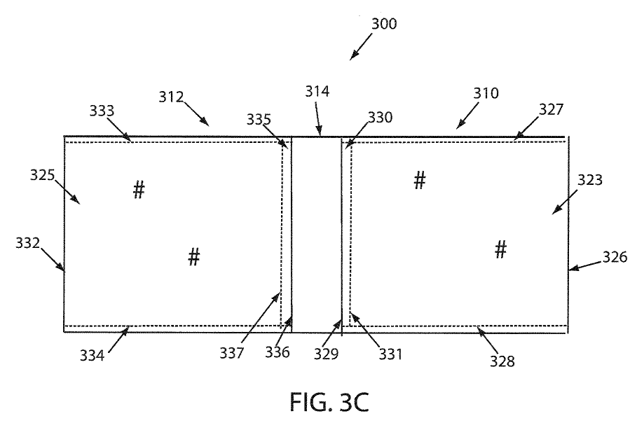

An album covering of the invention can be coupled to an album by various means, and can be permanently coupled, or removable. In a preferred embodiment, an album covering is removable to better facilitate covering the album, the personalizing the covering, the attaching adornments, and washing the album covering. FIG. 3A shows an example album covering 300. FIG. 3A shows a view of the covering 300 in which parts that cover inside surfaces of an album's front and rear covers can be seen. The album covering 300 is embodied as a removable covering having a front section 310 for covering an album front cover, a rear section 312 for covering an album rear cover, and a spine section 314 for covering an album spine. The front and rear sections 310, 312 are embodied as compartments configured to slidably receive the front and rear covers of an album. The front section 310 comprises an inner front portion 323 configured to cover an inside surface of an album front cover. The rear section 312 comprises an inner rear portion 325 for covering an inside surface of an album rear cover. The hashed marks shown in the spine section 314 indicate that the wrong side of a fabric is exposed. The inner front and rear portions, 323 and 325 respectively, substantially cover the inside surfaces 205, 209 of the album front and rear covers 202, 204, having an inner front vertical edge 317 and an inner rear vertical edge 319 that frame the spine section 314. The album cover 300 has generally vertical and horizontal edges and seams that follow the contours of an album cover to provide a snug fit while substantially covering the inner and outer surfaces of the album cover and further providing the appearance that the album is wearing a garment.

FIG. 3B shows the album covering 300 in which the inner front portion 323 has been lifted away from an outer front portion 322 of the front section 310 to better show that the front section 310 forms a compartment or pocket section which can receive a front cover of an album. An album front cover can be slid or inserted into the front section 310. Similarly, the inner rear portion 325 has been lifted from an outer rear portion 324 to better show how the rear section 312 is in the form of a compartment or pocket section that can receive a rear cover of an album. A rear cover of an album can be slid into the rear section 312. The hash marks indicate that a wrong side of a fabric is exposed, so that the wrong side of outer front portion 322, spine section 314, and outer rear portion 324 can be exposed. Thus the album covering 300 is in the form of a casing in which an album can be snugly encased.

FIG. 3C shows a view in which the album covering 300 is turned inside out, showing the reverse side of the fabric for inner front portion 323 and inner rear portion 325, to better reveal the album covering 300 construction. A fold 326 divides inner front portion 323 from outer front portion 322, the fold 326 configured to encase a front vertical edge of an album front cover. Inner front portion 323 is seamed to outer front portion 322 at a top seam 327 and at a bottom seam 328. In the example 300 the seams 327, 328 are serged. A front hem or facing 330 is formed by folding along fold 329, and stitching the folded back part to the wrong side of inner front portion 323 along a stitching line 331. In an example embodiment, the facing 330 is serged.

Similarly, a fold 332 divides the inner rear portion 325 from the outer rear portion 324; the fold 332 configured to encase a vertical edge of an album rear cover. Inner rear portion 325 is sewn to outer rear portion 324 at an upper seam 333 and a lower seam 334. A rear hem or facing 335 is formed by folding along fold 336, and stitching the folded back part to the wrong side of inner front portion 325 along a stitching line 337. In an example embodiment, the facing 336 is serged, however various other stitching styles can be employed, as known in the art. Thus it can be seen that in the example covering 300, sections 310 and 312 each form a compartment for receiving an album cover, allowing an album cover to be easily slid into and out of the covering 300.

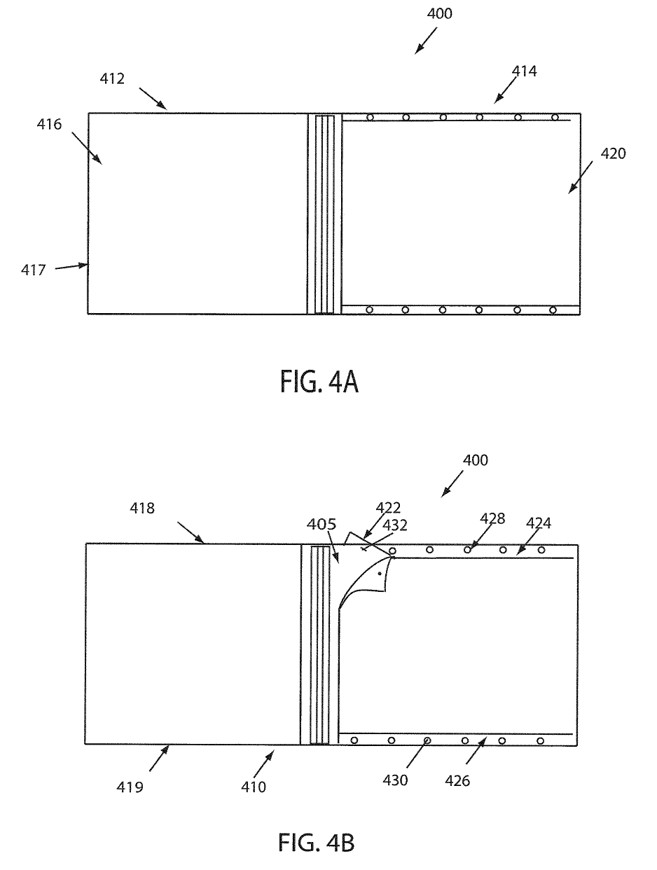

FIGS. 4A, 4B show an example embodiment 400 in which an album 405 is covered with an album covering 410. In both views, the album 405 is opened up with all pages removed. The album covering 410 has a front section 412 for covering a front cover of the album 405. The front section 412 has an inner front portion 416 for covering an inside surface of the album 405 front cover. The inner front portion 416 is differentiated from an outer front portion (not shown) configured to cover an outer surface of the album 405 front cover, by a fold 417. The fold 417 is configured to receive a front edge of the album 405 front cover. The inner front portion 416 is attached to an outer front portion (not shown in this view) at an upper seam 418 and at a lower seam 419. Together the inner front portion 416 and outer front portion define a compartment bounded on three sides by the fold 417, the upper seam 418 and the lower seam 419, in which a front cover of the album 405 can be slidably received.

A rear section 414 includes an inner rear portion 420 for covering an inside surface of the album 405 rear cover, and an outer rear portion 422 for covering the outside surface of the album 405 rear cover. The inner rear portion 420 can be attached to the outer rear portion 422 at an upper coupling zone 424 and a lower coupling zone 426. One or more coupling means 428 can be provided at the upper 424 and lower 426 coupling zones to couple the inner and outer rear portions 420, 422 so that the album cover 410 can be removably secured on the album 405. The coupling means 428 can be variously embodied. For example, the coupling means 428 can comprise a button and a buttonhole, wherein the button and buttonhole are configured to cooperate to couple the inner and outer rear portions 420 and 422. For example a pull-through button 430 can be sewn on inner rear portion 420 at the upper coupling zone 424 and a buttonhole 432 can be formed in outer rear portion 422 at the upper coupling zone 424. The button 430 and the corresponding buttonhole 432 can be configured so that the button 430 can be pulled through the buttonhole 432 to couple the inner and outer rear portions 420 and 422. As shown in FIG. 4B, the inner rear portion 420 can be detached from the outer rear portion 422 by slipping one or more buttons 430 through one or more corresponding buttonholes 432. After the inner and outer portion 420, 422 have been decoupled, the album 405 can easily be slipped out of the front section 412 and removed from the covering 410.

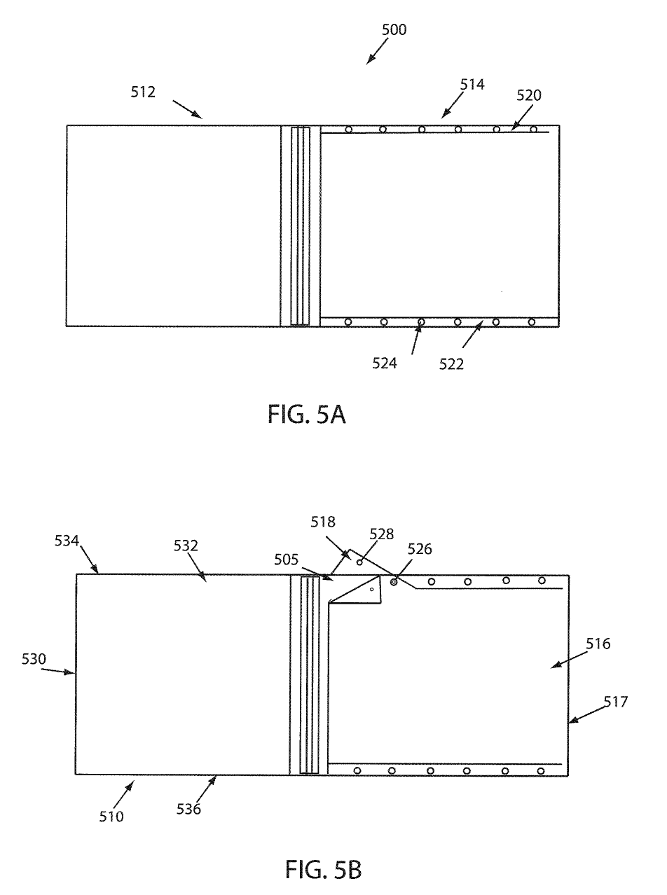

It is contemplated that various types of coupling means can be employed at a coupling zone. FIGS. 5A, 5B illustrate an example embodiment 500 in which a coupling means comprises snap buttons. As shown in FIGS. 5A,5B, an album 505 is covered with an album covering 510 that comprises a front section 512 and a rear section 514. The rear section 514 comprises an inner rear portion 516 configured to cover an inside surface of the album 505 rear cover, and an outer rear portion 518 configured to cover an outside surface of the album 505 rear cover. A fold 517 exists between the inner and outer rear portions 516, 518. The inner and outer rear portions are coupled together at an upper coupling zone 520 and a lower coupling zone 522, by a coupling means 524. In the embodiment 500, the coupling means 524 comprises a snap button in which a male subportion 526 is attached to the inner rear portion 516 and a female portion 528 is attached to the outer rear portion 516 so that corresponding male and female portions 526, 528 can be coupled together to snugly secure the album covering 510 on the album 505. The front section 512 comprises a compartment that can receive a front cover of the album 505 so that a front cover edge can be encased by a fold 530 that separates an inner front portion 532, configured to cover an inner surface of a front cover of the album 505, from an outer front portion (not shown) configured to cover an outer surface of an album 505 front cover. The inner front portion 532 can be attached to an outer front portion at an upper seam 534 and a lower seam 536 so that the upper and lower seams 534, 536 and the fold 530 define a compartment for slidably receiving a front cover of the album 505.

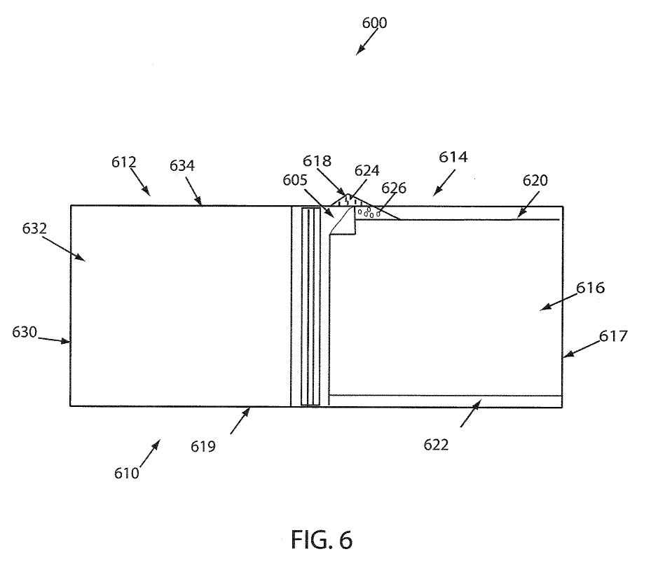

FIGS. 6A, 6B show an example embodiment 600 in which an album 605 is covered with an album covering 610. The album covering 610 comprises a front section 612 for covering a front cover of the album 605, and a rear section 614 for covering a rear cover of the album 605. The rear section 614 comprises an inner rear portion 616 for covering an inside surface of the album 605 rear cover, an outer rear portion 618 for covering an outside surface of the album 605 rear cover and a fold 617 between said inner and outer rear portions 616, 618 for encasing an edge of a rear cover of the album 605. The inner and outer rear portions 616, 618 are coupled together at an upper coupling zone 620 and a lower coupling zone 622 by a coupling means. In the example embodiment 600, a coupling means comprises hook and loop tape, wherein hook tape 624 is disposed on the outer rear portion 618 at the coupling zone 620, and a loop tape 626 is disposed on the inner rear portion 616 at the coupling zone 620, wherein said hook tape 624 and said loop tape 626 are configured to couple together to couple the inner and outer rear portions 616 and 618.

The front section 612 comprises a compartment that can receive a front cover of the album 605 so that a front cover edge can be encased by a fold 630 that separates an inner front portion 632, configured to cover an inner surface of a front cover of the album 605, from an outer front portion (not shown) configured to cover an outer surface of an album 605 front cover. The inner front portion 632 can be attached to an outer front portion at an upper seam 634 and a lower seam 636 so that the upper and lower seams 634, 636 and the fold 630 define a compartment for receiving a front cover of the album 605.

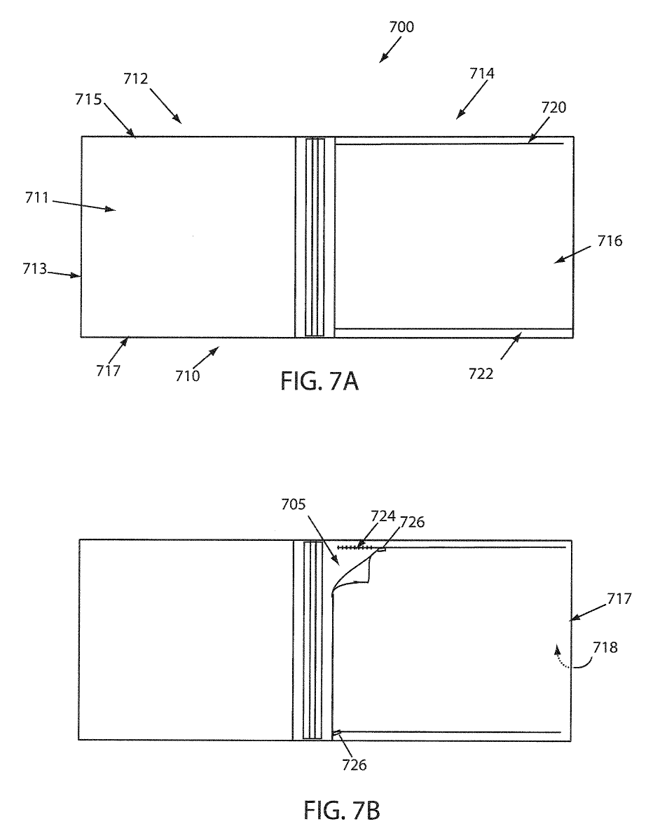

FIGS. 7A,7B show an example embodiment 700 in which an album 705 is covered with an album covering 710. The album covering 710 comprises a front section 712 for covering a front cover of the album 705, and a rear section 714 for covering a rear cover of the album 705. The front section 712 comprises an inner front portion 711 for covering an inside surface of the album 705, an outer front portion (not shown) for covering an outside surface of the album 705, and a fold 713 between the inner front portion 711 and an outer portion. The inner front portion 711 can be coupled to an outer front portion at an upper seam 715 and a lower seam 717, so that the inner front portion 711 and an outer portion form a compartment bounded by the fold 713 and the upper and lower seams 715, 717 that can slidably receive a front cover of the album 705 so that the inner portion 711 substantially covers the inside surface of the album 705 front cover.

The rear section 714 comprises an inner rear portion 716 for covering an inside surface of a rear cover of the album 705, an outer rear portion 718 for covering an outside surface of a rear cover of the album 705, and a fold 717 that differentiates said inner and outer rear portions 716, 718 and encases an edge of the album 705. The inner and outer portions 716, 718 are coupled one to another at an upper coupling zone 720 and a lower coupling zone 722 by a coupling means 724, which is embodied as a zipper having a zipper head 726.

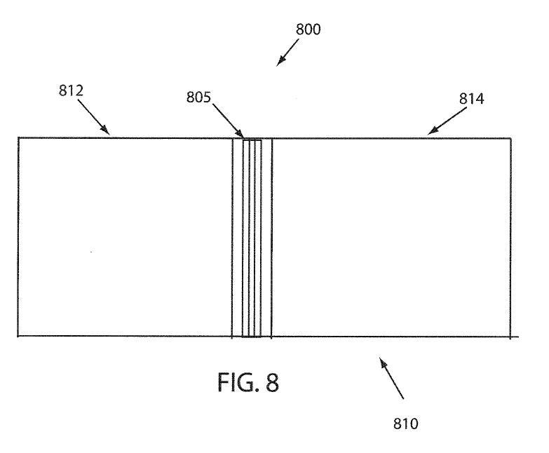

FIG. 8 shows an embodiment 800 in which an album 805 is covered with an album covering 810. The album covering 810 comprises a front section 812 for covering a front cover of an album, and a rear section 814 for covering a rear cover of an album. The front and rear sections are adhered to the front and rear covers of an album with an adhesive such as glue.

The foregoing provides various examples of forming and securing an album covering to an album. It is understood that any of the previously discussed means, as well as other means known in the art, can be used within the scope of the appended claims. The following paragraphs will focus on the outward appearance of an album covering. As stated previously herein, an album covering can be made from fabric and be configured to look like a garment so that a covered album appears to be wearing a garment. An album covering can be made from any type of fabric and be configured to appear as any type of garment, article of clothing, or combination of articles of clothing. The variety of looks or appearances allows for commemoration of a variety of events or time periods. In an example embodiment, an album covering can be configured to appear as a military uniform. This specific embodiment is particularly appealing to men and women in the armed services and their families. Photographs, articles, and other momentos associated with a serviceman's time of duty can be preserved in an album dedicated to the enlistment period. In addition, pins, medals, insignia, badges and the like can be properly positioned and attached to a military uniform covering to commemorate the achievement, preserve the medals, and replicate the appearance of the serviceman's actual uniform. An album covered with a military uniform covering commemorates a soldier's service and achievement and can be attractively displayed on a mantel, bookcase, coffee table, etc.

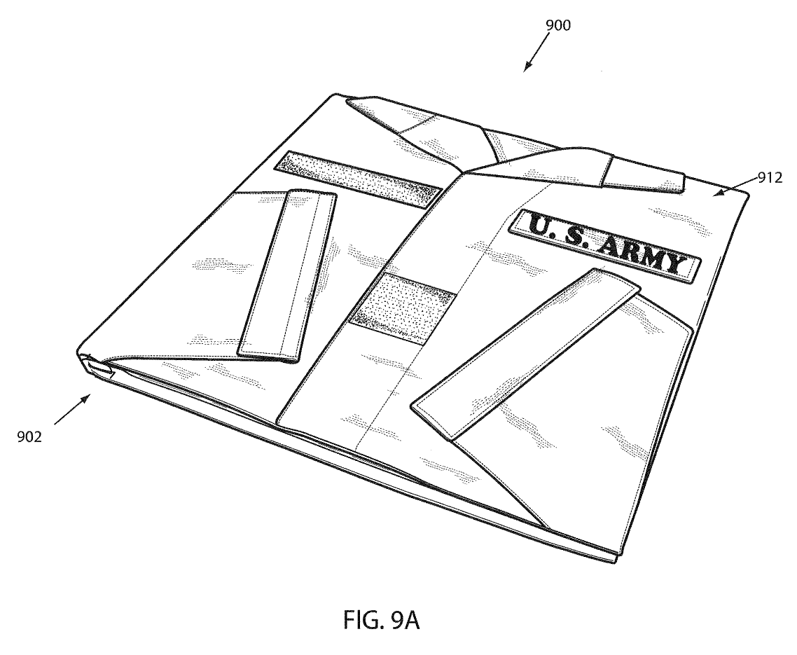

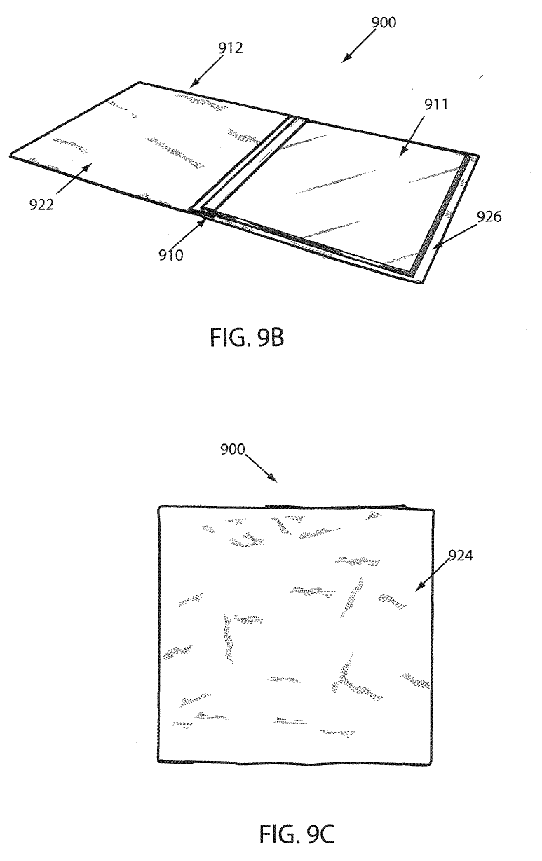

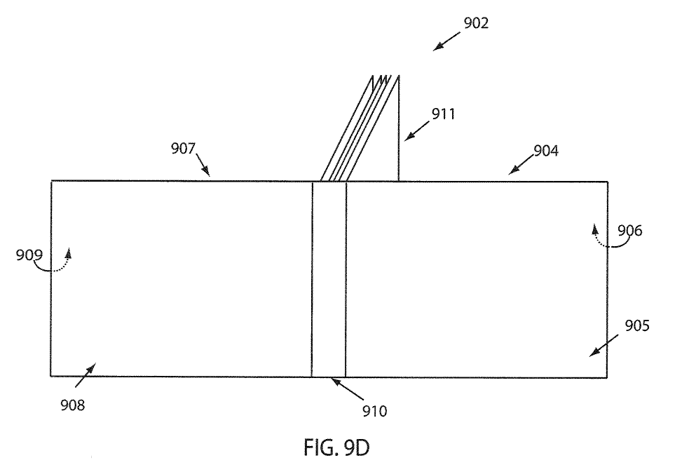

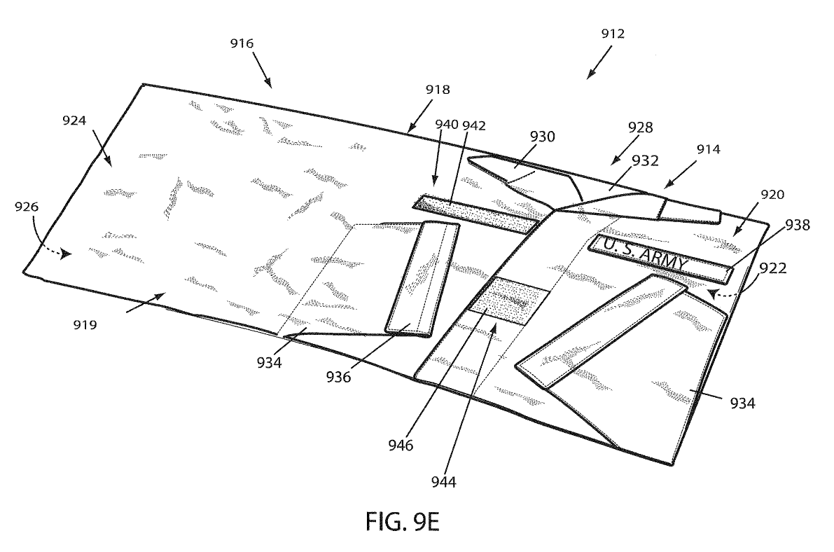

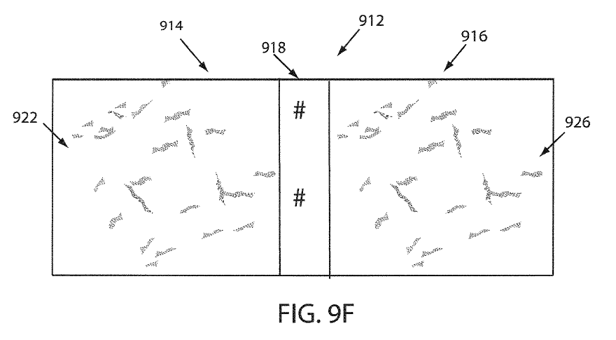

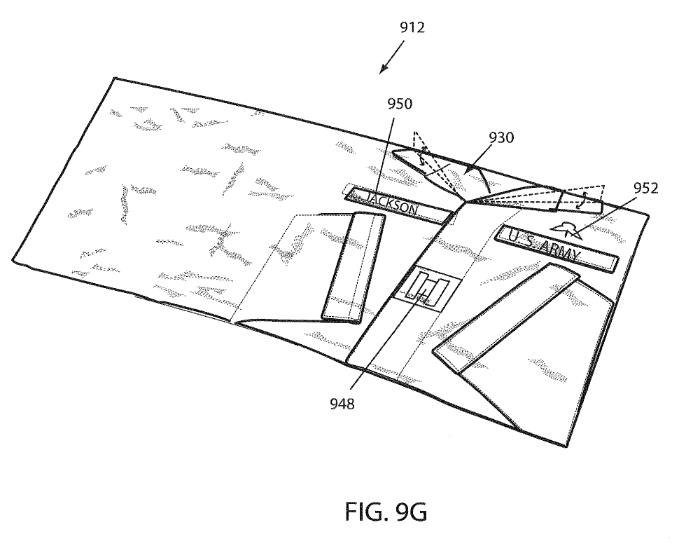

FIGS. 9A-9G show an example embodiment 900 which includes an album 90 covered with a military uniform covering 912 so that the album 902 appears to be wearing a military service uniform. FIGS. 9A, 9B show the album 902 covered with the military uniform covering 912, with FIG. 9B showing the covered album 900 in an opened position, and 9C showing the rear of the album when in a closed position. In an exemplary embodiment, the album covering 912 comprises authentic military fabric sourced from a military uniform fabric supplier. The military uniform covering 912 is configured to appear as a U.S. Army combat uniform. As will be discusser further below, it is contemplated that an album covering can be configured to appear as various military uniforms by using various fabrics, embellishments and adornments associated with different branches of armed services, and the different types of uniforms associated with each branch.

FIG. 9D shows the album 902 apart from the album covering 912. The album 902 has a front cover 904 having an outside surface 905 and an inside surface 906. The album 902 has a rear cover 907 having an outside surface 908 and an inside surface 909. A spine portion 910 provides a means for attaching pages 911 to the album 902. In an example embodiment, the front and rear covers 904, 907 measure 13¾″ in width and 12¾″ in height, and the front and rear outside surfaces 905, 908 comprise dark-colored canvas.

FIGS. 9E, 9F and 9G show the military uniform covering 912 apart from the album 902, and spread out. The military uniform covering 912 comprises a front section 914 for covering the album front cover 904, a rear section 916 for covering an album rear cover 907, and a spine section 918 for covering the spine portion 910 of the album 902. A single piece of fabric forms a base layer 919 that extends seamlessly through the rear portion 916, the spine portion 918 and at least a part of the front section 914 to provide a continuous look that supports the impression that the album is wearing a garment. The covering 912 can include embellishments that render an appearance of a garment, in this case a military uniform. The front section 914 comprises an outer front portion 920 for covering an outside surface 905 of the album front cover 904, and an inner front portion 922 for covering an inside surface 906 of the album front cover 904. Similarly, the rear section 916 comprises an outer rear portion 924 for covering an outside surface 908 of the album rear cover 906, and an inner rear portion 926 for covering an inside surface 909 of the album rear cover 906. The covering 912 is configured to slidably receive the album 902, and be removable from the album 902.

The front section 914 is embellished with a plurality of attributes that give it an appearance of a military uniform. A neckline portion 928 includes a collar 930 configured to appear similar to a collar on a U.S. Army combat uniform. As shown in FIG. 9G, the collar 930, can be a loose collar configured to be lifted up. For example, an upper edge of the collar 930 can be stitched down at an upper seam, such as the upper seam 327 of FIG. 3C, while lower portions of the collar 930 can be lifted up to facilitate pinning of insignia and the like.

The neckline portion 928 can include an underlayer 932 configured to provide a layered look in which an album appears to be wearing layered clothing. For example, the covering 912 is configured to appear as a collared shirt over an undershirt. The underlayer 932 is configured to provide cover for a part of the album 902 that would otherwise be exposed by the collar 930, as well as to add to the appearance of a complete U.S. Army combat uniform, which can include an undershirt. The collared shirt is made of a first fabric, that which comprises the base layer 919; a second fabric can be used to give the appearance of an undershirt underneath the collared shirt. In an example embodiment, both the base panel 919 fabric and the second fabric used in the underlayer 919 comprise authentic military service uniform fabric from an authorized military uniform fabric supplier. For example, the base panel 919 fabric can be a combat camouflage fabric, and the underlayer 932 fabric can be a solid-colored fabric. In an example embodiment, a safeguard layer of fabric (not shown), concealed underneath the underlayer 932 can be sewn across the wrong sides of underlayer 932 and base layer 919 to prevent the underlayer 932 seams from catching the album cover 904 as it is inserted in the front section 914 of the album covering 912. The safeguard layer of fabric can also prevent the collar 930 from stretching. In an exemplary embodiment, first and/or second fabrics can comprise machine-washable fabric comprising cotton, nylon, a combination of cotton/nylon or other fabric, and can also comprise moisture-wicking fabric. The uniform fabric can be summer weight or winter weight fabric.

The front section 914 can further include one or more pockets 934. The pocket 934 can be a functional pocket configured to receive and store one or more items, just as a front pocket on a military uniform shirt. In an exemplary embodiment the pocket 934 is sized to conform with specifications pertaining to military uniform pockets, in this case specifications for front pockets on a U.S. Army combat uniform shirt. The pocket 934 can be associated with a pocket flap 936 which can be lifted to access an opening to the pocket 934. In an exemplary embodiment, the pocket flap 936 complies with U.S. Army uniform standards. The pocket flap 936 can be removably attached to the album covering 912 by a coupling means, for example hook and loop tape. In an exemplary embodiment, the pocket flap 926 is attached to the album covering 912 in the same manner as a pocket flap is attached to an official U.S. Army uniform. For example, the pocket flap 926 can be configured with hook tape adapted to couple with loop tape positioned on the album covering 912.

A service tape 938 can adorn the military uniform covering 912. As known in the military service, a service tape is configured to attach to a military uniform and identify the military branch in which a serviceman is enlisted. The service tape 938 identifies the military service as the U.S. Army, further adding to the appearance of an Army combat uniform. The service tape 938 can comprise an authentic military uniform service tape such as those available from a military supply vendor. In an exemplary embodiment, a service tape is configured to attach to a military uniform covering in the same manner as a service tape attaches to an authentic military uniform. As an adornment for a U.S. Army album covering, the service tape 938 is removably coupled to the military uniform covering 912 by hook and loop tape. For example, the service tape 938 can be configured with hook tape on its reverse side, and the album covering 912 can be configured with loop tape so that the service tape 938 can be coupled to the uniform covering 912.

The military uniform album covering 912 can be configured to receive a name tape. As known in the military, a name tape displays a soldier's name, for example a soldier's name can be embroidered or stitched on a name tape that is attached to the soldier's uniform. The album covering 912 includes a name tape zone 940 configured to receive a name tape. A coupling means can be provided at the name tape zone 940 to couple a name tape to the album covering 912. In an exemplary embodiment, an authentic military name tape from a military supply store can be coupled to the album covering 912 in the same manner that a military name tape is coupled to a military uniform. For example, a U.S. Army name tape can be coupled to the album covering 912 at the name tape zone 940. Because an authentic U.S. Army combat uniform includes a name tape coupled to the uniform with hook and loop tape, the album covering 912 can include loop tape 942 at the name tape zone 940 configured to couple with hook tape on a reverse side of a U.S. Army name tape to facilitate coupling of a U.S. Army name tape to the album covering 912. In an exemplary embodiment, the letters of a name can be embroidered on a name tape, and the embroidered name tape attached to the album covering 912 at the name tape zone 940. In an example embodiment, a user can purchase a kit that includes the album 902 and the album covering 912. The kit can further include a name tape. The user can have a name embroidered on the name tape, then attach the name tape to the album covering 912. In an exemplary embodiment, the user can deliver the name tape to embroidery services at a military exchange so that the name tape can be embroidered in a manner that complies with military standards. Alternatively, a purchaser may request embroidery services at the time a kit is ordered, and the kit can be delivered with an embroidered name tape. Thus the family of a U.S. Army soldier can preserve photographs, medals and momentos of the soldier's service in an album having a covering that has the appearance of the soldier's uniform personalized with the soldier's name.

A military uniform album covering can be configured for attachment and proper placement of rank insignia, skill badges, medals and other accouterments, and in an exemplary embodiment, be configured to allow attachment of such adornments in a position and manner consistent with that used in the attachment of such items to an official military uniform, e.g. hook and loop tape, stitching, pinning, etc. Military standards for pin placement on uniforms are detailed and specific, and must be respected by those serving in the armed forces. A military uniform covering of the invention allows a user to position insignia, medals, badges, name and service tapes and other accouterments in their proper places, for example on a collar, above a pocket, in the shirt center, etc. in accordance with military specifications. Thus when the album is displayed, it can appear as an official military uniform, and present the skills achieved, merits awarded and rank earned in a manner consistent with military specifications, something that is important to a U.S. serviceman. Prior art albums and album covers, including those discussed herein, generally fail to allow proper placement of insignia, medals and other accouterments. In an exemplary embodiment, the album covering 912 is configured to be removable from the album 902 to facilitate sewing or pinning of medals and other adornments in their proper placements, i.e. in compliance with military standards. The album covering 912 includes an adornment zone 944 configured for attachment of an adornment, such as a rank insignia. Because the album covering 912 is configured to replicate a U.S. Army uniform, it is configured to receive rank insignia in the same manner as an official U.S. Army uniform. Accordingly, loop tape 946 is present at the adornment zone 944 and is configured to couple with hook tape on an insignia patch. FIG. 9E shows the album covering 912 having rank insignia 948, name tape 950, and service skill badge 952 attached. The service skill badge 952, as well as other adornments, can comprise authentic military items obtained from a military supply source and attached to the album covering 912 in the same manner as that used in attaching adornments to a soldier's actual uniform. As can be seen from FIG. 9E, the collar 930 on the album covering 912 is a loose collar that can be lifted up and away from the rest of the album covering 912.

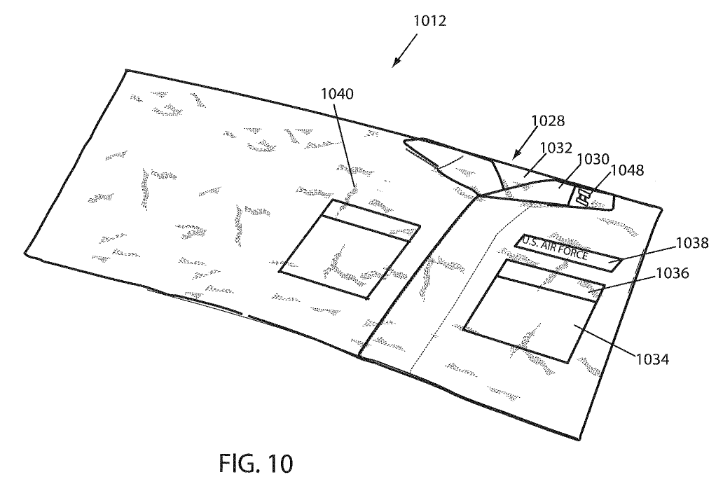

The embodiment 900 has the appearance of a U.S. Army uniform. It is contemplated that an album covering can have the appearance of various United States or foreign military uniforms by varying the fabric, embellishments and adornments. For example, FIG. 10 depicts an example embodiment of an album covering 1012 configured to appear as a U.S. Air Force (USAF) uniform, in particular a USAF combat uniform. The album covering 1012 has a neckline portion 1028 with a collar 1030. An underlayer 1032 has the appearance of a USAF undershirt. The collar 1030 is loose and can be lifted to facilitate proper pinning of rank insignia 1048, which, on an authentic USAF uniform is pinned on a collar. For example, while stitched to the album covering 1012 at an upper portion, lower portions of the collar 1030 can be lifted up. Pockets 1034, which, in an exemplary embodiment are fully functional, are configured to replicate and be oriented in the same manner as pockets on an authentic USAF combat uniform. Pocket flaps 1036, associated with the pockets 1034 can be configured to cover the pocket 1034 opening and be attached in the same manner as that used to attach flaps to an authentic military uniform. In a USAF uniform covering, an upper portion of the flaps 1036 can be stitched to the album covering 1012 above the pockets 1034. A lower portion of the flaps 1036 can be removably coupled to the pockets 1034. The flaps 1036 can be lifted up to access the interior of the pocket 1034. A service tape 1038 can be attached to the covering 1012, for example by stitching, which is the manner by which a service tape is attached to an authentic USAF uniform. An authentic USAF name tape can be coupled to the covering 1012 at name tape zone 1040 configured to allow proper placement of a USAF name tape. In an exemplary embodiment, a user can have a name tape embroidered with a soldier's name and attached to the covering 1012, for example stitched to the covering 1012, which is the manner by which a name tape is attached to an authentic USAF combat uniform.

The embodiments 900 and 1000 are illustrative examples of an album covered with an album covering having a military uniform appearance. An album can be configured to appear as combat fatigues, a dress uniform, or other military attire, for any branch of service, including foreign services. In addition, album covering can replicate a uniform of decades past, both in fabric and embellishments to commemorate service in previous wars. The military uniform album covering both protects and enhances the appearance of an album or scrapbook. The military uniform covering commemorates the enlisted service of a member of the armed services, and provides a means for preserving and displaying medals and honors earned since medals, ribbons, and the like can easily be attached to the covering, properly placed in accordance with military specifications. A military uniform covering commemorates a veteran's service, facilitates personalization, and proves a novel, remarkable appearance for an album. A military uniform covering made from authentic military uniform fabric can be washed to maintain an attractive appearance even after extensive handling.

As mentioned previously herein, an album covering can be embodied as a sports or other organization uniform as well. Because an album covering can include a loose collar, pockets, flaps, and the like, and be configured for easy removal and reinsertion of an album, accouterments on various types of uniforms can be pinned or attached in their proper positions as dictated by team or organization specifications for authentic uniforms. For example, team logo, skill badges and patches, identification, and other adornments can be attached to an album covering in the same manner and position as they are attached to an authentic uniform.

As required, exemplary embodiments of the invention have been described in detail herein. By its embellishment, an album covering can be configured to appear as a garment, and thereby enhance the outward appearance of a photograph album, scrapbook, or the like, as well as commemorate an occasion or particular time period in a person's life. An album covering can be configured to appear as a military uniform, commemorating a person's service to his/her country. Alternatively, an album covering can be configured to appear as other apparel, formal or casual, to commemorate an event such as a birthday, baptism, dance recital, prom, graduation, wedding, vacation, safari, or other event. In addition to an event, an album covering of the invention can commemorate a particular time period, such as infancy, toddler years, sports or scouts membership, high school, college, or years engaged in a particular occupation such as fireman, policeman, doctor, etc. An album covering can be configured to cover an album in such a manner that an album appears to be wearing a garment. In an exemplary embodiment, an album covering comprises a front section having embellishment that can include a neckline portion. An album covering can have further embellishments such as collars, pockets, pocket flaps, buttons, coupling means, identification means, darts, pleats or other embellishments that can further configure the album covering to appear as an article of clothing. An album covering can include an underlayer so that the album covering appears as a layered garment. An album covering can be configured for attachment of adornments such as medals, rank insignia, jewelry, patches, and the like. When embodied as a uniform, for example a military uniform, an album covering can be configured to allow proper placement of rank insignia, name tape, service tape, and the like, for example, on a collar, above a left pocket, etc. in accordance with the standards imposed on an authentic uniform worn by a member of the armed services. In an example embodiment, an album cover can be configured to slidingly receive an album, facilitating its use by a consumer; and, in addition, be configured to be removable from an album. In an exemplary embodiment a kit can include an album and an album covering configured to snugly receive the album. In an example embodiment, the album covering snugly fits an accompanying album, substantially covering its surfaces, but is removable to facilitate attachment of various adornments. One or more adornments which can be attached to the album covering can be included in select kit embodiments so that an album covering can be personalized for an individual.

While the invention has been disclosed in its preferred forms, it will be apparent to those skilled in the art that many modifications, additions, and deletions can be made therein without departing from the spirit and scope of the invention and its equivalents, as set forth in the following claims.

I claim:

1. An album covering, comprising:
a front section configured to cover a front cover of an album, said front section comprising a first fabric, said front section comprising an outer portion for covering an outer surface of said front cover and an inner portion for covering an inner surface of said front cover,
a spine section configured to cover a spine of said album;
a rear section configured to cover a rear cover of said album; and
wherein said covering, having an embellishment, is configured to appear as a garment made of said first fabric.

2. The album covering of claim 1, wherein said covering is removable.

3. The album covering of claim 1, wherein said front section comprises a compartment for slidingly receiving said front cover of said album.

4. The album covering of claim 1, wherein said embellishment comprises a neckline portion configured to appear as a neckline of a garment.

5. The album covering of claim 4, wherein said neckline comprises a liftable collar.

6. The album covering of claim 1, wherein a single layer of said first fabric seamlessly extends through said front, spine and rear sections.

7. The album covering of claim 1, wherein said outer front portion comprises at least one functional pocket.

8. The album covering of claim 1, wherein said garment is a uniform.

9. The album covering of claim 8, wherein said covering is configured for proper accouterment placement on said uniform.

10. An album kit comprising:
an album having a front cover, a rear cover, and a spine portion;
an album covering comprising:
a front section configured to cover said album front cover, said front section comprising a first fabric and an embellishment,
a rear section configured to cover said album rear cover,
a spine section configured to cover said album spine;
wherein, by said embellishment, said front section is configured to appear as a garment made from said fabric.

11. The album kit of claim 10, wherein said covering is removable.

12. The album kit of claim 10, wherein said garment is a uniform.

13. The album kit of claim 12, wherein said album covering is configured for proper positioning of an adornment.

14. The album kit of claim 12, wherein said uniform is a military uniform.

15. The album kit of claim 10, further comprising an adornment for said covering.

16. The album kit of claim 15, wherein said adornment comprises a name tape.

17. A military service album covering, comprising:
a front section configured to cover a front cover of an album, said front section comprising a first fabric;
a spine section configured to cover a spine of said album;
a rear section configured to cover a rear cover of said album;
wherein said covering has an embellishment and is configured to appear as a military uniform.

18. The military service album covering of claim 17, wherein said embellishment comprises a loose collar.

19. The military service album covering of claim 17, wherein said front section includes at least one functional pocket.

20. The military service album covering of claim 17, wherein said front section is configured for attachment of a military adornment.

21. The military service album covering of claim 20, wherein said album covering is configured for proper positioning of said adornment.
